(19) United States
(12) Patent Application Publication
(10) Pub. No.: US 2014/0047612 A1
(43) Pub. Date: Feb. 20, 2014

(54) Hand Guard for Artists

(71) Applicant: Ronald W. Schoultz, Bismarck, AR (US)

(72) Inventor: Ronald W. Schoultz, Bismarck, AR (US)

(21) Appl. No.: 13/968,105

(22) Filed: Aug. 15, 2013

Related U.S. Application Data
(60) Provisional application No. 61/683,266, filed on Aug. 15, 2012.

(51) Int. Cl. B44D 3/00

(52) U.S. Cl. CPC B44D 3/00
USPC 2/16

(57) ABSTRACT

A hand guard for artists including a base piece; a palm piece joined to the base piece; a first securing piece joined to the base piece to secure the hand guard to the hand of a wearer of the hand guard; and a second securing piece joined to the palm piece to secure the hand guard to a hand of a wearer of the hand guard. The wearer of the hand guard has greater hand control when writing and drawing because the wearer is able to rest the base piece of the hand guard on the working surface.

### CROSS-REFERENCE TO RELATED APPLICATIONS

This application claims the benefit of U.S. Provisional Application No. 61/683,266, entitled “Hand Guard for Artists” and filed on Aug. 15, 2012. The complete disclosure of said provisional patent application is hereby incorporated by reference.

### STATEMENT REGARDING FEDERALLY SPONSORED RESEARCH OR DEVELOPMENT

Not applicable

### BACKGROUND OF THE INVENTION

1. Field of the Invention

The present invention relates to a hand guard and, more specifically, to a hand guard for artists that allows the artist to steady their hand by the resting the hand guard on the working surface for support while drawing and prevents smudging by limiting the exposure of the hand to the working surface.

2. Brief Description of the Related Art

Artists, especially those creating pencil or ink drawings, have two major challenges in creating those works. First, it is very common for artists to unintentionally smudge their work as their hand moves across the working surface (e.g. paper). Second, many artists have trouble keeping a steady hand when drawing. This can be increasingly challenging for disabled artists and all artists as they get older in age.

It would therefore be desirable to develop a hand guard that allows the artist to steady their hand by resting the hand guard on the working surface for support while drawing and prevent smudging by limiting the exposure of the hand to the working surface.

### BRIEF SUMMARY OF THE INVENTION

The present invention is directed to a hand guard for artists comprising a base piece; a palm piece joined to the base piece; a first securing piece joined to the base piece, wherein the first securing piece is operable to secure the hand guard to the hand of a wearer of the hand guard; and a second securing piece joined to the palm piece, wherein the second securing piece is operable to secure the hand guard to a hand of a wearer of the hand guard.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of the hand guard of the present invention.

FIG. 2 is a perspective view of the hand guard of the present invention.

FIG. 3 is a perspective view of the hand guard of the present invention on the hand of an artist.

FIG. 4 is a perspective view of the hand guard of the present invention on the hand of an artist.

### DETAILED DESCRIPTION OF THE INVENTION

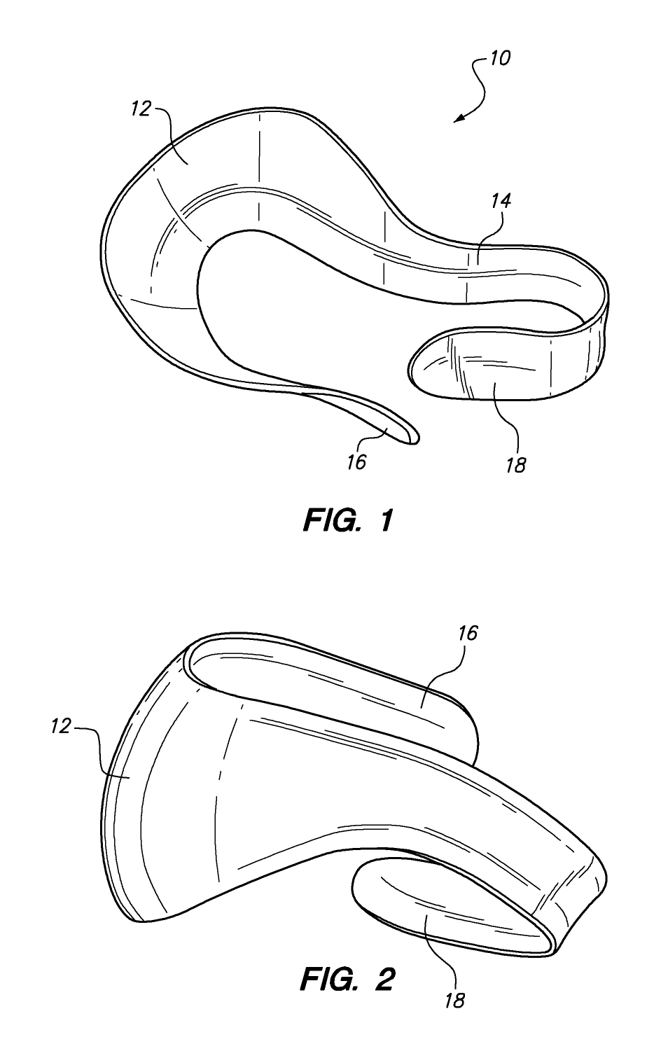

With reference to FIGS. 1-4, the preferred embodiments of the present invention may be described.

The hand guard 10 is preferably made of plastic or other similar materials that are durable, light-weight, and smooth-surfaced. The hand guard 10 is an irregular shape as shown in FIGS. 1-2. The hand guard 10 is comprised of a base piece 12 and a palm piece 14. The base piece 12 is at one end, or the lower portion, of the hand guard 10. As shown in FIGS. 1-2, the base piece 12 is a U-shaped arch. Joined to the base piece 12 is the palm piece 14 of the hand guard 10. The palm piece 14 is substantially an upside-down U-shaped arch as shown in FIG. 1.

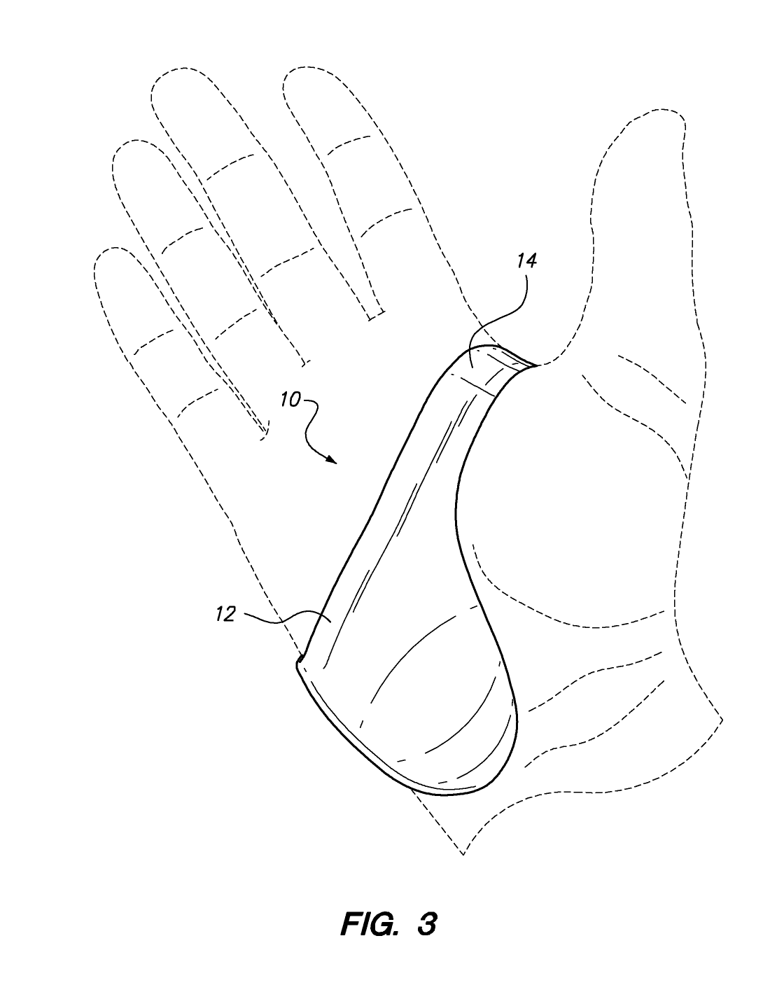

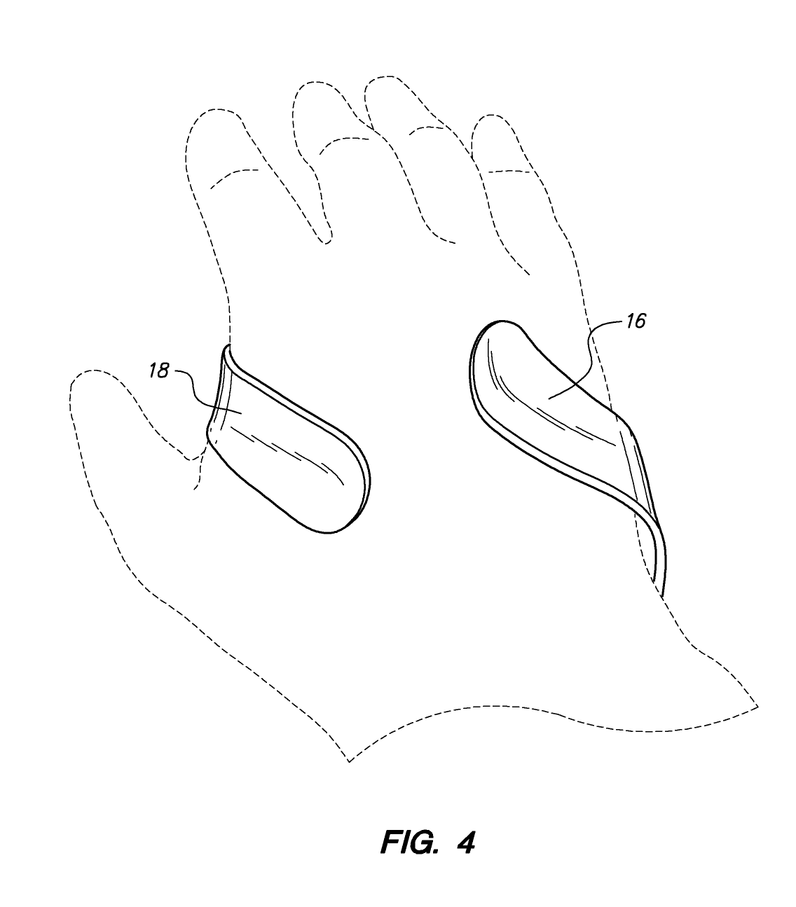

The hand guard 10 is intended to be worn on the dominant hand (i.e. the hand the wearer writes with) of the wearer. As shown in FIGS. 3, when the hand guard 10 is worn, the base piece 12 of the hand guard 10 is positioned below the pinky finger of the wearer and along the base of the hand. The palm piece 14 of the hand guard 10 is positioned across the palm of the hand of the wearer and curves between the thumb and index finger of the wearer. Joined at opposite ends of the base piece 12 and the palm piece 14 of the hand guard 10 are securing pieces 16, 18. As shown in FIG. 4, securing piece 16 is joined to the base piece and flushly contacts the back of the hand of the wearer and securing piece 18 is joined to the palm piece 14 and also flushly contacts the back of the hand of the wearer. Together, the securing pieces 16, 18 secure the hand guard 10 to the wearer during use.

In an alternative embodiment, a strap (not shown) or other means for securing the hand guard 10 to the hand is connected to the hand guard 10. On opposite sides of the base piece 12 are holes (not shown). The top of the palm piece 14 of the hand guard 10 also has at least one hole. The holes are preferably rectangular in shape. The holes are capable of receiving a strap or other means for securing the hand piece to the hand of the artist. In one embodiment, the strap is a VELCRO® strap. The strap can be threaded through the holes of the hand piece and wrapped around the back of the hand to secure the hand guard 10 to the hand of the wearer. It should be understood that the dimensions of the hand guard will vary depending on the size of the hand of the wearer of the hand guard 10.

The inventor has observed that lead from pencils and ink from pens are not easily transferred from the working surface to the plastic material of the hand guard 10. The wearer of the hand guard 10 is able to rest the base piece 14 of the hand guard 10 on the working surface with little risk of smudging the work. Because the plastic material of the hand guard 10 is substantially smooth, the inventor has observed that the hand guard 10 moves across the surface of the working surface with little resistance. The inventor has also observed that the wearer of the hand guard 10 has greater hand control when writing and drawing, including people with medical conditions characterized by shaking hands (e.g. Parkinson's disease). The inventor, therefore, believes that the hand guard 10 has great potential as a therapeutic and/or rehabilitation medical device.

The present invention has been described with reference to certain preferred and alternative embodiments that are intended to be exemplary only and not limiting to the full scope of the present invention as set forth in the appended claims.

We claim:

1. A hand guard for artists comprising:
(a) a base piece;
(b) a palm piece joined to said base piece;
(c) a first securing piece joined to said base piece, wherein said first securing piece is operable to secure said hand guard to a hand of a wearer of said hand guard; and
(d) a second securing piece joined to said palm piece, wherein said second securing piece is operable to secure said hand guard to a hand of a wearer of said hand guard.

2. The hand guard of claim 1, wherein said hand guard is made of plastic.

3. The hand guard of claim 1, further comprising a strap.
